(19) United States
(12) Patent Application Publication
(10) Pub. No.: US 2024/0066418 A1
(43) Pub. Date: Feb. 29, 2024

(54) Folding Toy Theatre

(71) Applicant: Sam Joyce, Swindon (GB)

(72) Inventor: Sam Joyce, Swindon (GB)

(21) Appl. No.: 18/347,508

(22) Filed: Jul. 5, 2023

(30) Foreign Application Priority Data
Jul. 12, 2022 (GB) GB2210217.2

(51) Int. Cl. A63H 3/52; A63H 3/08

(52) U.S. Cl. CPC A63H 3/52; A63H 3/08

(57) ABSTRACT

A folding toy theatre with characters that move using just one finger, comprising a theatre surround with side flaps which fold backwards allowing it to stand upright, the front face has a cut central aperture and a slot cut out at its bottom face edge. The characters have a long forward flap from the base of the body to action it and two flaps at the left and right sides of the body which fold backwards to keep the character upright. The character is placed inside the theatre surround the long forward flap passes through the bottom face slot of the theatre surround so the character can be moved from the front of the theatre. The theatre surround can have slots in its side flaps, a tabbed background can be added or the side flaps have a slot and latch to join directly.

### BACKGROUND OF THE INVENTION

The invention is generally related to folding card theatre toys including die cut pieces which are designed to be easily and quickly assembled by hand and without the need for glue or scissors or other cutting tools, and assembled into a three dimensional operational theatre.

Folding toy theatres have been produced for children as toys for many years. To allow characters to be moved some have solid rods attached to the front of the character element, some have lateral flaps coming from one side or the top whereby the characters are inserted into the theatre surround at the top or sides via a slot or opening meaning a user has to reach to the sides or top of the theatre to operate the characters.

In previous theatre examples only one character can be moved with one hand whereby users must clasp the flap or rod with two fingers.

### SUMMARY OF THE INVENTION

This invention allows a user to construct a fully folding theatre and characters but offers a solution to operate multiple characters more conveniently from the front of the theatre with one hand whereby one finger is only needed to move a character within the theatre surround, for example character A would be moved with the index finger, character B would be moved independently with the forefinger on the same hand, the users other hand could also operate multiple characters.

### BRIEF DESCRIPTION OF DRAWINGS

FIG. 1 shows the theatre character in its flat unfolded two dimensional state.

FIG. 2 shows the theatre character folded to its final embodiment as a three dimensional form, able to stand upright on a flat surface.

FIG. 3 shows the theatre surround from reverse side with the side flaps folded into position with a theatre character located in place.

FIG. 4 shows a front view of the theatre surround with the side flaps folded backwards with a character in its final position to be moved by a user.

FIG. 5 shows a separate background element which can be added and secured in place using tabs and slots.

FIG. 6 shows the background element in place.

FIG. 7 shows another embodiment of the side flaps whereby they have tabs and slots on their outside edges to allow them to join to each other directly.

FIG. 8 shows the joined side flaps now forming a triangular three dimensional shape.

### DETAILED DESCRIPTION OF THE INVENTION

The following detailed description refers to the accompanying drawings In the preferred embodiment the characters are die cut from a flat two dimensional sheet of material, a plurality of characters can be joined in their packaged form by perforated lines on their outside flap edges and can be separated for use by pressure pulling apart. The characters comprise of a long flap that folds from the bottom of the character body approximately ninety degrees upwards and flaps at the left and right side of the character body that fold preferably at approximately ninety degrees backwards which allows the character to stand as a three dimensional form upright on a flat surface.

The theatre surround is cut from a flat two dimensional piece of material and has left and right side flaps which fold backwards preferably at approximately ninety degrees allowing it to stand upright on a flat surface as a three dimensional form. It has a cut aperture in its front face where the characters will be seen, it has a thin slot cut out of the front face section at the bottom. When characters are placed inside the theatre surround behind the front face, the long forward flap can pass through the front face bottom slot of the theatre surround and therefore protrude forward from under the front of the theatre surround. A plurality of characters can then be added and moved using one finger per character.

A background element is added to the theatre surround by adding cut slots in the top section of the left and right supporting side flaps and a separate die cut back section with protruding tabs at its left and right edges can slot and latch into the left and right side flaps and be held in place at the back of the theatre surround. This background element can have a decorative image relative to the theatre theme on one side and a space left blank for a hand written message opportunity on reverse. When the user opens the card the message element can be read and then reversed and set into the theatre surround as a background.

Another embodiment of the theatre surround would be to make the left and right flaps longer then create a tab and slot latching system at the outside edges of the left and right flaps, whereby the outside edge of the left flap would have protruding tabs, the outside edge of the right flap would have slots, the flaps would then fold backwards at preferably approximately forty five degrees and latch together forming a triangle allowing it to stand upright on a flat surface as a three dimensional form and therefore having an internal background element. A hand written messaging area could be added to the side flaps outside surface so the message can be seen on the outside back facing section of the theatre surround.

Visual instructions on how the elements are constructed can be printed onto one side of the outside flaps or supplied on a separate sheet. When the theatre is packaged in its point of sale location it would have a promotional cover showing the theatre assembled in play position seen facing outwards from the packaged toy to demonstrate the item. When the theatre packs away all elements can return to their unfolded flat two dimensional state for storage to be reassembled in the same way to play again, for example in a supplied envelope. The theatre and characters can be posted using the envelope supplied. The theatre and characters material is preferably die cut card, creasing on the fold lines makes construction of the elements simpler. No glue or other fixing aids are needed.

The invention is demonstrated visually in the accompanying drawings in which: In FIG. 1, a character is shown in its flat two dimensional state as a single piece of material comprising of the character body 1, two lateral flaps left and right at the bottom sides of the character body 2,3, and a long flap from the bottom of the character body downwards 4, the character has visual lines to indicate folds and would be pre-creased to allow ease of folding. The character body in this example is a girl but other images such as animals can be made with similar features.

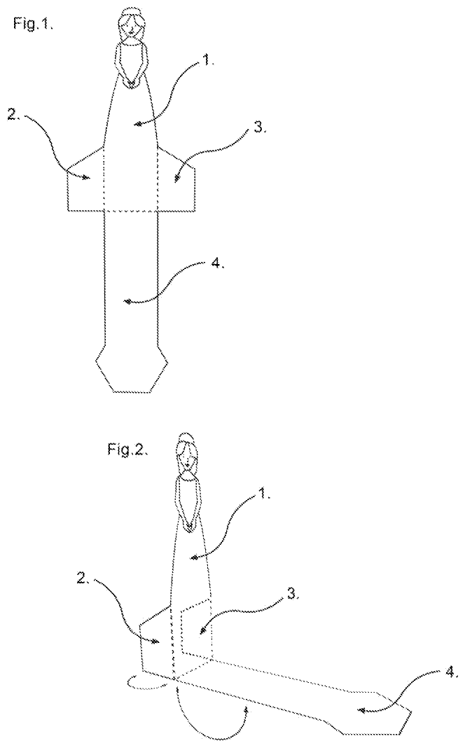

In FIG. 2, the left and right lateral flaps of the character 2,3, are folded backwards preferably at approximately ninety degrees, the long downward flap 4, is folded approximately ninety degrees upwards, the character will then stand upright on a flat surface as a three dimensional form.

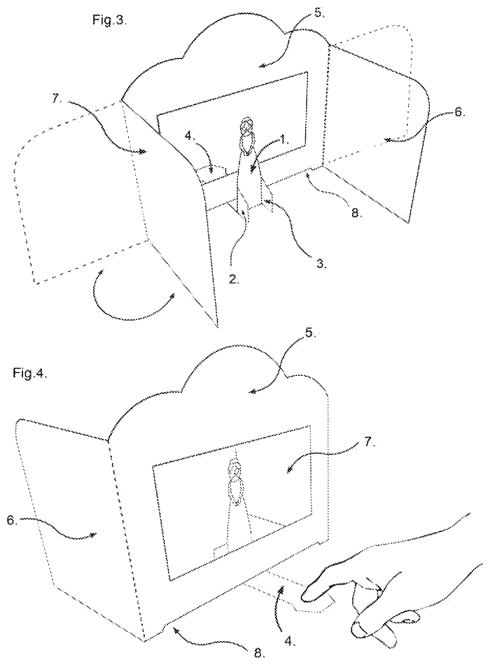

In FIG. 3, the reverse of the theatre surround 5,6,7, is shown, it has two left and right sides 6,7, which fold preferably at approximately ninety degrees backwards to enable it to stand upright as a three dimensional form. The dashed lines represent the left and right flaps 6,7 before they were folded in their two dimensional state. The theatre character 1,2,3,4, is placed inside whereby its long forward flap 4, passes through a slot 8, cut out of the base of the theatre surround front 5, the two left and right lateral flaps of the character 2,3, act as a support to keep the character body 1, upright at approximately ninety degrees in a straight position inside the theatre surround 5,6,7.

In FIG. 4, the front of the theatre surround 5,6,7, is shown with the character in place in its play position. A user can move the theatre character using just one finger placed on the forward flap 4, therefore a plurality of figures can be added and moved using one finger per character allowing one hand to move multiples of characters.

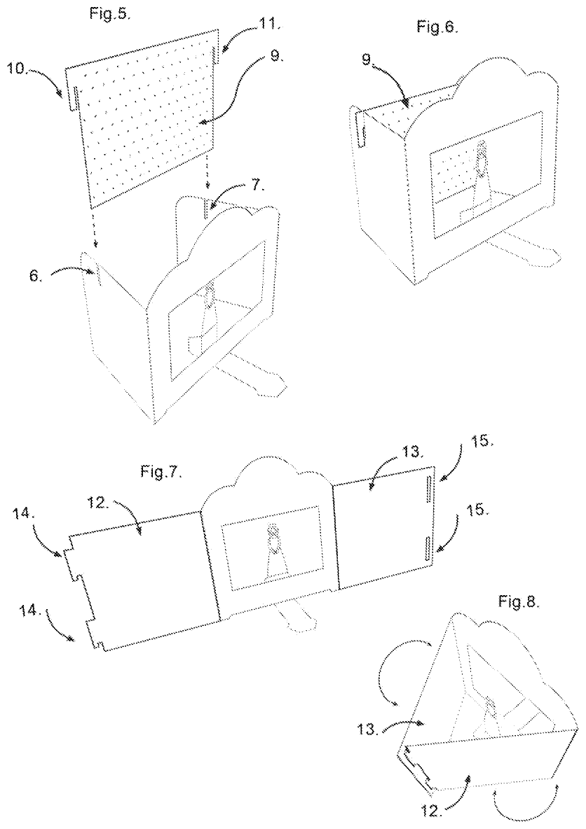

In FIG. 5, a two dimensional die cut background element is shown 9, it can have a printed image on its face and a blank messaging area on its reverse. It has two protruding tabs from its left and right upper side 10,11. The theatre surround left and right side flaps 6,7, have a slot cut in their top side 6,7, to enable the tabs 10,11, to be located in place and hold the background 9, in position.

In FIG. 6, the background 9, is shown in its final position with the latching tabs located into the slots of the side flaps of the theatre surround.

In FIG. 7, an alternative embodiment of the theatre surround is shown. The left side flap 12, has two protruding tabs 14, in its outer edge. The right side flap 13, has two slots 15, in its outer side.

In FIG. 8, The left and right flaps 12,13, fold backwards at approximately forty five degrees and the tabs 14, and slots 15, latch together to form a three dimensional triangular shape which will stand up in its own right. This creates a background visual element by way of a printed image on the left and right flaps inside the theatre surround, a blank area on the reverse of one of the flaps can allow for hand written messaging.

1. A folding toy theatre with characters that can be moved with just one finger, comprising:
(a) a theatre surround cut from a flat sheet of material with left and right side flaps which fold back at approximately ninety degrees, the front face section has a cut out central aperture and a cut out slot at the bottom edge,
(b) a plurality of characters cut from a flat sheet of material which have a flap that folds from the bottom of the character body approximately ninety degrees upwards and flaps at the left and right side of the character body that fold preferably at approximately ninety degrees backwards.

2. A folding toy theatre with characters that can be moved with just one finger according to claim 1, to which a background element is attached using cut out slots in the theatre surround side flaps, the background element being a separate cut element with protruding latching tabs at its left and right edges which latch into the slots in the theatre surround side flaps.

3. A folding toy theatre with characters that can be moved with just one finger according to claim 1, whereby the theatre surround left and right side flaps are longer and have a tab and slot latching element added at their outside edges which latch together forming a triangular theatre surround structure.
